(19) United States
(12) Patent Application Publication
(10) Pub. No.: US 2015/0106547 A1
(43) Pub. Date: Apr. 16, 2015

(54) DISTRIBUTED MEMORY SYSTEMS AND METHODS

(71) Applicant: Micron Technology, Inc., Boise, ID (US)

(72) Inventor: Gregory A. King, Hastings, MN (US)

(73) Assignee: Micron Technology, Inc., Boise, ID (US)

(21) Appl. No.: 14/053,303

(22) Filed: Oct. 14, 2013

(51) Int. Cl. G06F 3/06

(52) U.S. Cl. CPC G06F 3/0625; G06F 3/0679; G06F 3/0658
USPC 711/103; 711/149

(57) ABSTRACT

Apparatuses and methods are disclosed herein, including those that operate to receive memory requests from a processor over a high-speed communication interface and distribute the requests among a plurality of memory storage devices over lower-speed communication interfaces.

### TECHNICAL FIELD

Various embodiments described herein relate to systems and methods associated with semiconductor memory.

### BACKGROUND INFORMATION

The evolution of software application and operating system technology has increased demand for higher-density memory subsystems. However, conventional-technology memory subsystems often represent a compromise between performance and density. Conventional memory subsystems may also exhibit a lack of memory power optimization.

### BRIEF DESCRIPTION OF THE DRAWINGS

FIG. 1 is a block diagram of a memory module in accordance with some embodiments.

FIG. 2 is a block diagram of a memory control device in accordance with some embodiments.

FIG. 3 is a block diagram of a memory storage device in accordance with some embodiments.

FIG. 4-5 are flow diagrams illustrating methods in accordance with some embodiments.

### DETAILED DESCRIPTION

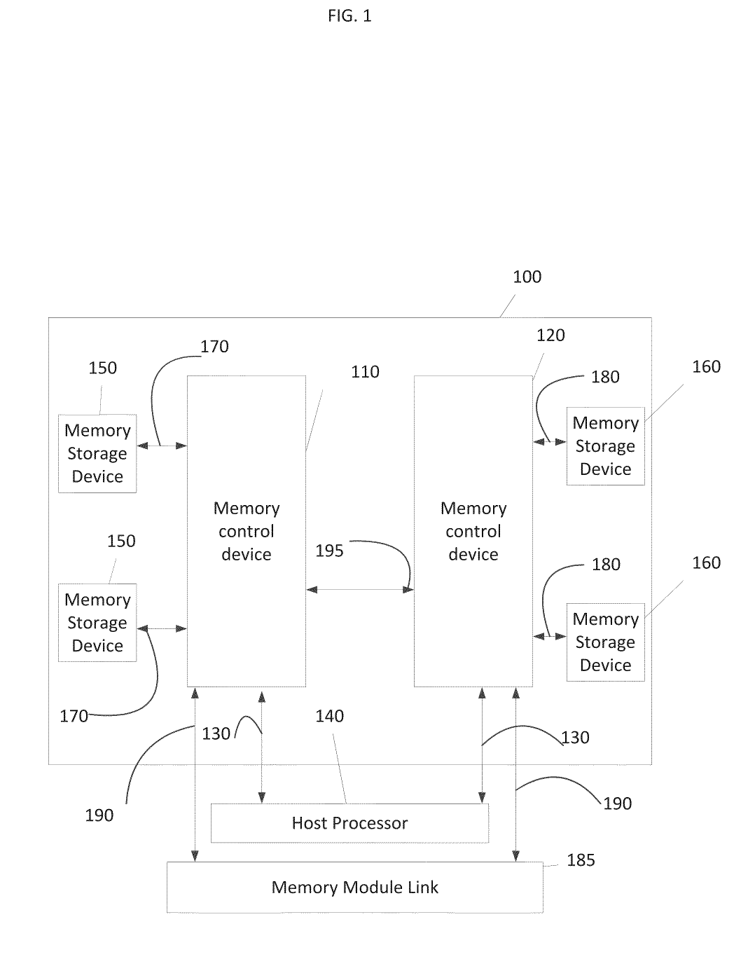

FIG. 1 is a block diagram of a memory module 100 in accordance with some embodiments. Current memory technologies may require large amounts of power, with high latency, in order to maintain memory operation in high-density memory systems. In many embodiments, one or more memory control devices 110, 120 may operate to accept and respond to host processor 140 requests and distribute the requests to memory storage devices 150,160 of the memory module 100. This distribution mechanism and method may allow improved memory density with reduced power usage and reduced latency.

A memory module 100 in accordance with some embodiments may include a memory control device 110 and another memory control device 120. The memory control device 110 may include a communication interface 130 of a first type to couple to a host processor 140. The memory control device 120 may also couple to the host processor 140 through a communication interface 130 of the first type. The memory module 100 may be a dual inline memory module (DIMM). While FIG. 1 illustrates two memory control devices 110 and 120, some embodiments may include only one memory control device or more than two memory control devices.

The memory module 100 may include a first plurality of memory storage devices 150, coupled to the memory control device 110 and a second plurality of memory storage devices 160 coupled to the memory control device 120. While FIG. 1 shows four memory storage devices, some embodiments may include more than four memory storage devices to increase memory density of the memory module 100 and some embodiments may include fewer than four memory storage devices. For example, the memory control device 110 may couple to only one memory storage device 150, or the memory control device 110 may couple to more than two memory storage devices 150.

A memory storage device 150 may couple to the memory control device 110 through a communication interface 170. The communication interface 170 may be of a second type different from or the same as the type of the communication interface 130. The communication interface 170 may operate at the same or at a lower bitrate or power than the communication interface 130.

A memory storage device 160 may couple to the memory control device 120 through a communication interface 180. The communication interface 180 may be of a type different from or the same as the type of the communication interface 130 or the communication interface 170.

The memory control device 110 may couple to at least one of the second plurality of memory storage devices 160 to provide a redundant communications interface for accessing those memory storage devices. For example, the memory storage device 160 may be coupled to the memory control device 110 through an additional communication interface (not shown in FIG. 1), to provide a redundant communication interface for accessing memory address locations in the memory storage device 160 in case of failure of the communication interface 180.

The memory control device 120 may couple to at least one of the first plurality of memory storage devices 150 to provide a redundant communications interface for accessing those memory storage devices. For example, a memory storage device 150 may couple to the memory control device 120 through an additional communication interface (not shown in FIG. 1), to provide a redundant communication interface for accessing memory address locations in the memory storage device 150 in case of failure of the communication interface 170.

The memory control device 110 or 120 may couple to a memory module link 185 through an interface 190 to communicate with other memory modules in a computing system. Multiple memory modules (not shown in FIG. 1) may be daisy chained and the host processor 140 may use an abstracted memory interface protocol to reduce or eliminate latency.

The interface 190 may be a Serializer/Deserializer (SerDes) interface, a Cube Connect Interface (CCI), or any other type of interface. The interface 190 may operate at a higher bitrate or the same bitrate as the communication interfaces 130. A CCI may be a single-ended ground-referenced interface. The CCI may operate unidirectionally in some embodiments, or bidirectionally in some other embodiments. The CCI may utilize reduced power or startup time relative to a SerDes interface. In some embodiments, at least because the CCI may be a simpler interface that runs at a lower frequency than the SerDes interface, the CCI may utilize a relatively simpler or faster training algorithm than the SerDes interface does on power-up. In some embodiments, the CCI for communicating with a memory storage device 150, 160 to be accessed implements training algorithms on power up and other CCIs may not implement training algorithms. Because of the granularity and modularity of the distributed CCI interfaces, therefore, startup time of the memory module 100 may be reduced. Further, in contrast to SerDes, the CCI may not serialize and de-serialize high-speed serial bit streams to and from slower core clock domains into the high-speed serial clock domains. Accordingly, the CCI may have reduced latency relative to a SerDes interface.

A memory control device 110 or 120, or the host processor 140, may reduce latency by tracking address requests or processor requests. The memory control device 110, 120, or the host processor 140, may move high-use data that is deeper in a memory module 100 or on a deeper memory module in a chain of memory modules (not shown in FIG. 1) to the front of the memory module 100 or to the front memory module in a chain of memory modules.

At least one of the memory storage devices 150, 160 may comprise a memory storage die arranged in a vertical stack with a logic die. A memory storage device 150, 160 may include a logic die to implement additional distribution operations, control snapshot backups, redundancy operations, error correction, or other control and management operations. The logic die may also execute logic to decrease internal power to the power level needed for self-refresh of memory locations. The logic die may control a transition between active and non-active states of the corresponding memory storage device 150, 160.

At least one of the memory storage devices 150, 160 may comprise a vertical stack of memory storage dies and no logic die. A memory storage device 150, 160 may not include a logic die in order to limit logic transistor count to reduce minimize leakage power in the memory storage device 150, 160.

At least one of the memory storage devices 150, 160 may be a NAND-architecture flash memory device. A memory storage device 150, 160 may operate at half of the CCI bandwidth. A memory storage device 150, 160 may include a redundant pass-through CCI to provide an additional communication path to other memory storage devices 150, 160 or memory control devices 110, 120 in cases of failure of a communication path to any memory storage device 150, 160 or memory control device 110, 120.

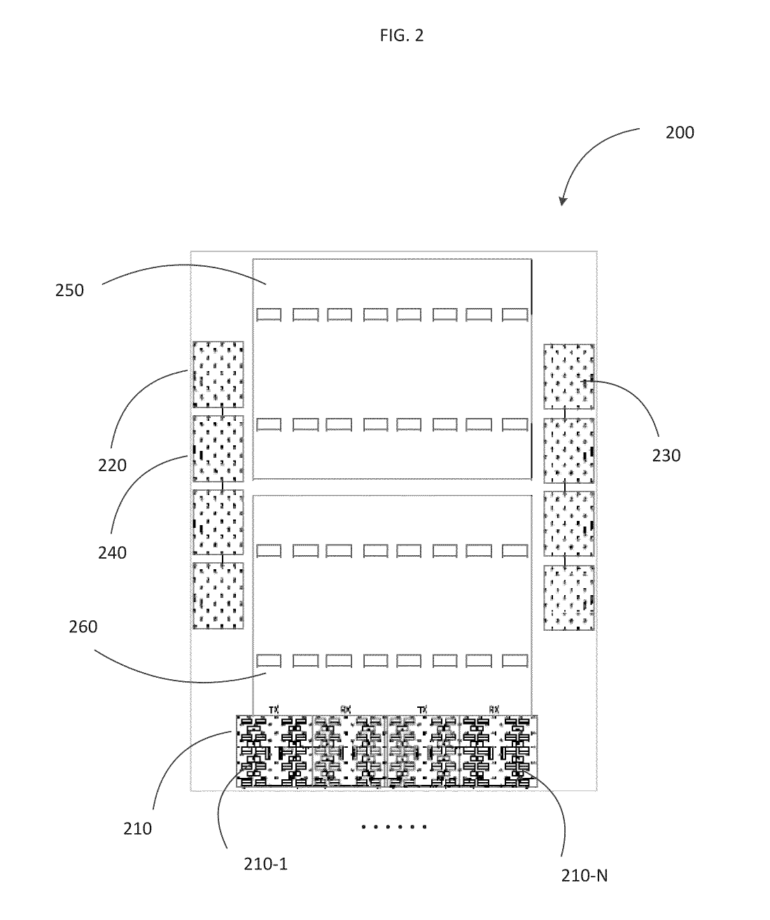

FIG. 2 is a block diagram of a memory control device 200. The memory control device 200 may be operable to serve as the memory control device 110 or 120 in the memory module 100 (FIG. 1). The memory control device 200 may comprise a communication interface 210 to communicate with the host processor 140 (FIG. 1). The communication interface 210 may be a SerDes interface. The communication interface 210 may include two or more communication lanes 210-1 through 210-N. The memory control device 200 may include a redundant communication interface and forwarded clock (not shown in FIG. 1) for communicating with the host processor 140. The redundant communication interface may serve to double the bandwidth of communications or to provide redundancy for cases of failure of the communication interface 210.

The memory control device 200 may include a communication interface 220 to communicate with a memory storage device (not shown in FIG. 2) remote from the memory control device 200. The communication interface 220 may be operable to serve as a communication interface of the plurality of communication interfaces 170 (FIG. 1).

The communication interface 220 may operate at a lower power than the communication interface 210. The communication interface 220 may operate at a lower bitrate than the communication interface 210. For example, the communication interface 220 may operate at 2.5 gigabits per second (Gb/s) while the communication interface 210 may operate at 10 Gb/s. The communication interface 210 may operate at a higher bandwidth than the second communication interface 220. The communication interface 210 may be an optical interface while the communication interface 220 may be other than an optical interface. For example, the communication interface 220 may be a SerDes interface, a CCI, The communication interface 220 may be a SerDes interface or the communication interface 220 may be other than a SerDes interface. For example, the communication interface 220 may be a CCI as described above with respect to FIG. 1.

The memory control device 200 may reduce power at lower data rates by operating the CCI in a source-terminated mode to reduce or eliminate termination currents. As the memory control device 200 begins to operate with faster signaling rates or uses lower quality channels, the physical layer may enable receive termination to improve signal integrity at the cost of increased power. When a memory transfer or other access to a memory storage module is complete, the memory control device 200 may reduce or eliminate output power of a CCI.

The CCI interface may comprise a number of data lanes, set at design time of the physical CCI interface, to generate a desired data width and a bandwidth in accordance with memory module 100 requirements. The CCI interface may further comprise a forwarded clock for data capture. The CCI interface may be modular and adaptable in both lane count and data rate between the memory control device 200 and any of the plurality of memory storage devices 150, 160 (FIG. 1). The adaptability and modularity of the CCI interfaces may allow a faster transition from idle to active states of the memory storage devices 150, 160 and power consumption may be reduced because not all of the memory storage devices 150, 160 will necessarily be active at one time.

The memory control device 200 may include a communication interface 230 to communicate with a memory storage device (not shown in FIG. 2) remote from the memory control device 200. The communication interface 230 may be of the same type as or of a different type than the communication interface 220. For example, the communication interface 230 may be a CCI interface and the communication interface 220 may be a SerDes interface. The communication interface 230 may operate at a different bitrate or at a different power than the communication interface 220 regardless of whether or not the communication interface 230 and the communication interface 220 are of the same type.

The memory control device 200 may comprise a communication interface 240 to communicate with a memory control device (not shown in FIG. 2). The communication interface 240 may operate at a higher power or at a higher bitrate than one or both of the communication interface 220 and the communication interface 230.

The communication interface 220, the communication interface 230, or the communication interface 240 may each communicate with more than one memory storage device or memory control device (not shown in FIG. 2). For example, the communication interface 220 may be arranged in a “clam shell” configuration to communicate with multiple memory storage devices or multiple memory control devices to provide increased memory density while still including a limited number of communication interfaces.

The communication interface 220, the communication interface 230, or the communication interface 240 may each communicate with the same memory storage device or memory control device (not shown in FIG. 2). This communication between common memory storage devices or memory control devices may provide redundancy so that failure of any communication interface may not result in an inability to access a memory storage device or memory control device. Additional communication interfaces (not shown in FIG. 2) may be included to communicate with the same memory storage device or memory control device as any of the communication interface 220, the communication interface 230 or the communication interface 240. A communication interface may communicate with two different memory control devices or memory storage devices at half bandwidth in cases of failure of another communication interface to one of those memory control devices or memory storage devices.

While eight communication interfaces are shown in FIG. 2 for communicating with memory storage devices or other memory control devices (not shown in FIG. 2), the memory control device 200 may include any number of communication interfaces for communicating with memory storage devices or memory control devices.

The memory control device 200 may comprise a memory storage die 250. While FIG. 2 illustrates a memory control device 200 with one memory storage die 250, the memory control device 200 may include zero memory storage dies or any other number of memory storage dies.

The memory control device 200 may include a logic die 260. The logic die 260 may couple to the memory storage die 250. The logic die 260 may be arranged in a vertical stack with the memory storage die 250. The logic die 260 may also be arranged in a different configuration with the memory storage die 250. For example, the logic die 260 may be arranged adjacent to the memory storage die 250. The logic die 260 may contain control structures to accept and respond to memory requests received from the host processor 140 (FIG. 1) over the communication interface 210. The logic die 260 may forward instructions and aggregate data from other memory control devices that may reside on the memory module 100 (FIG. 1) or on other memory modules through the link 185.

The logic die 260 may process a memory request received over the communication interface 210 from the host processor (not shown in FIG. 2) to determine which memory storage device among multiple memory storage devices in communication with the memory control device 200 is being addressed by the memory request. The logic die 260 may distribute the messages between the communication interface 220 and the communication interface 230 based on the determining.

In some embodiments, the memory control device 200 may perform operations, such as memory request operations, on the memory storage devices 150, 160 (FIG. 1) using clock signals, to reduce or eliminate the need for a phase locked loop (PLL) and reference clock to that memory storage device 150, 160.

A memory control device 200 may additionally include a data port (not shown in FIG. 2), for example a Peripheral Component Interconnect (PCI) port, for backup and bulk storage to a solid state drive (SSD) for fast boot or memory restore options directly to the memory module 100, or by sharing restore capabilities across a plurality of memory modules. In a multiple DIMM card system, these options could provide additional redundancy options by sharing restore capability across multiple DIMM cards.

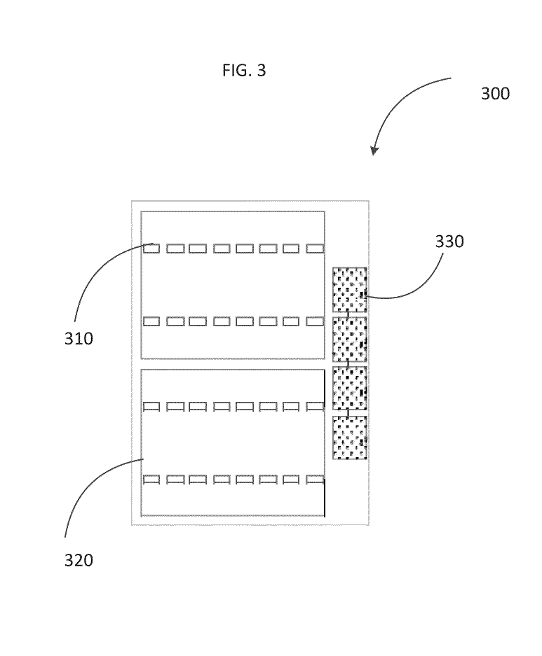

FIG. 3 illustrates a memory storage device 300 in accordance with some embodiments. The memory storage device 300 may be operable to serve as a memory storage device 150, 160 (FIG. 1). The memory storage device 300 may include a memory storage die 310, and a logic die 320. Alternatively, the memory storage device 300 may not include one or both of a memory storage die 310 and a logic die 320. The logic die 320 may be arranged in a vertical stack with the memory storage die 310. The memory storage device 300 may include a NAND-architecture flash memory device. The memory storage device 300 may include communication interfaces 330 for communicating with memory control devices or other memory storage devices as described above with respect to FIG. 1-2.

Modules described above in accordance with some embodiments may include hardware circuitry, optical components, single or multi-processor circuits, memory circuits, software program modules and objects encoded in a computer-readable medium (but not software listings), firmware, and combinations thereof, as desired by the architect of the memory module 100 and as appropriate for particular implementations of some embodiments.

Some embodiments may comprise or be incorporated into electronic circuitry used in computers, communication and signal processing circuitry, single-processor or multi-processor modules, single or multiple embedded processors, multi-core processors, data switches, and application-specific modules including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., MP3 (Motion Picture Experts Group, Audio Layer 3) players), vehicles, medical devices (e.g., heart monitor, blood pressure monitor, etc.), set top boxes, and others. Some embodiments may include a number of methods.

Some embodiments may include a machine-readable medium that may store one or more sets of instructions (e.g., software) embodying any one or more of the methodologies or functions described herein. The instructions may reside, completely or at least partially, in any combination including the host processor 140, a memory control device 110 or 120 (FIG. 1), and within the memory control device 200 (FIG. 2) during execution thereof by the memory module 100, with the host processor 140 and the memory control devices 110, 120 and 200 also constituting machine-readable media.

For example, the machine-readable medium, when executed on the memory control device 110, may cause the memory control device 110 to receive, over a Serializer/Deserializer (SerDes) interface, a memory request from a host processor 140 (FIG. 1).

The machine-readable medium may cause the memory control device 110 to select, based on the memory request, an identity of a memory storage device 150 that the memory control device 110 may access. The memory storage device 150 may be included in a plurality of memory storage devices 150 coupled to the memory control device 110 over a respective plurality of communication interfaces 170. The plurality of communication interfaces 170 may comprise SerDes interfaces. A first subset of the plurality of communication interfaces 170 may comprise SerDes interfaces and a second subset of the plurality of communication interfaces 170 may comprise CCIs. The plurality of communication interfaces 170 may comprise CCIs.

The machine-readable medium may cause the memory control device 110 to apply power to the respective communication interface 170 of the memory storage device 150 that the memory control device 110 will access. The machine-readable medium may cause the memory control device 110 to access memory in the memory storage device based on the memory access request. The machine-readable medium may cause the memory control device 110 to remove power from the respective communication interface 170 upon completion of the access.

The machine-readable medium may cause the memory control device 110 to detect whether a memory control device 120 provides a communication path to the memory storage device 150 responsive to detecting that the respective communication interface 170 to the memory storage device 150 has failed. The computer-readable medium may cause the memory control device 110 to provide the memory request to the memory control device 120 based on the detecting.

The machine-readable medium may cause the memory control device 110 to set a bit rate for communication on a communication interface 170 of the plurality of communication interfaces 170 to a first bit rate. The computer-readable medium may cause the memory control device 110 to set a bit rate for communication on a communication interface 170 of the plurality of communication interfaces 170 to a second bit rate different from the first bit rate.

As a further example, the machine-readable medium, when executed on the host processor 140, may cause the host processor 140 to receive an instruction for backing up memory. The host processor 140 may receive the instruction at, for example, an operating system (OS) executing on the host processor 140. The instruction may be received from, for example, other applications executing on the host processor 140 or within a computing system (not shown in FIG. 1) incorporating the host processor 140. The host processor 140 may send the instruction, over a communication interface 130 of a first type, to a memory control device 110 (FIG. 1). The host processor 140 may add or append an indication to the instruction indicating that the backing up is to be done to a memory storage device 150 over a communication interface 170 of a second type different from the first type. The memory storage device 150 may be a NAND-architecture device for non-volatile memory storage. The instructions may instruct the memory control device 110 to back up data remotely, for example on a memory storage that is not part of the memory module 100. The instructions may instruct the memory control device 110 to back up the data, using an optical communication interface, to a remote storage.

The machine-readable medium, when executed on the host processor 140, may cause the host processor 140 to instruct the memory control device 110 to perform an action on the memory storage device 150. For example, the memory control device 110 may be instructed to perform data operations or memory accesses on the memory storage device. The host processor 140 may instruct the memory control device 110 to store the result of the action at the memory control device 110 without sending the result of the action to the host processor 140. For example, the memory control device 110 may store the result of the action on the memory storage die 250 (FIG. 2), on another memory storage device 150, or on a remote device.

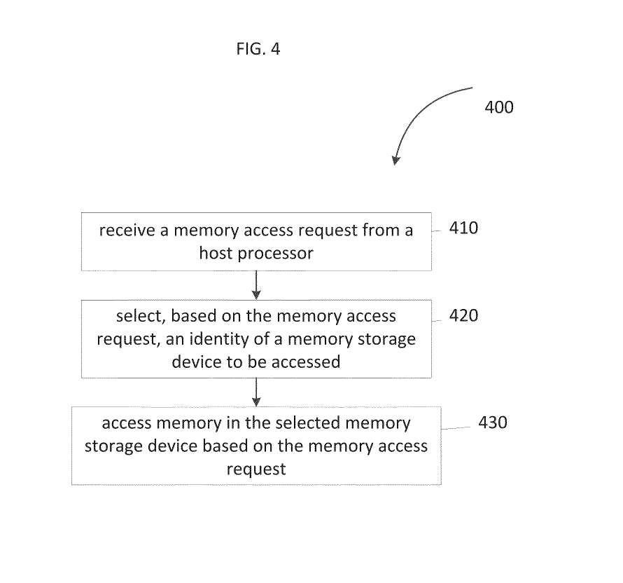

FIG. 4 is a flow diagram illustrating a method 400 of operating a memory module 100 in accordance with some embodiments. The method 400 may be performed by a memory control device 110 or 120 (FIG. 1) or a memory control device 200 (FIG. 2).

In operation 410, a memory control device 110 may receive a memory request from a host processor 140. The memory control device 110 may receive the memory request over a communication interface 130 of a first type. The communication interface 130 of the first type may be a Serializer/Deserializer (SerDes) interface.

In operation 420, the memory control device 110 may select, based on the memory request, an identity of a memory storage device 150 to be accessed. The memory storage device 150 may be one of a plurality of memory storage devices 150 coupled to the memory control device 110 by a plurality of respective communication interfaces 170 of a second type. The communication interface 130 of the first type may operate at a higher bitrate than communication interfaces 170 of the second type. The communication interface 130 of the first type may operate at a similar bitrate as the communication interface 170 of the second type. The memory control device 110 may apply power to the respective communication interface 170 responsive to selecting memory storage device 150.

In operation 430, the memory control device 110 may access memory in the selected memory storage device 150 based on the memory request. The memory control device 110 may remove power from the communication interface 170 upon completion of the memory request.

The memory control device 110 may perform an operation based on memory bits retrieved from a memory storage device 150 without passing memory bits to the host processor 140. The memory control device 110 may detect that the communication interface 170 to a memory storage device 150 or the communication interface 195 to a memory control device 120 has failed. The memory control device 110 may select another communication interface (not shown in FIG. 1) to use for communication with the memory storage device 150 or the memory control device 120.

The memory control device 110 may back up data to a backup memory storage (not shown in FIG. 1) of the memory module 100. The backup memory storage may be, for example, a NAND-architecture flash memory device. The memory control device 110 may back up data to a remote storage not on the memory module 100.

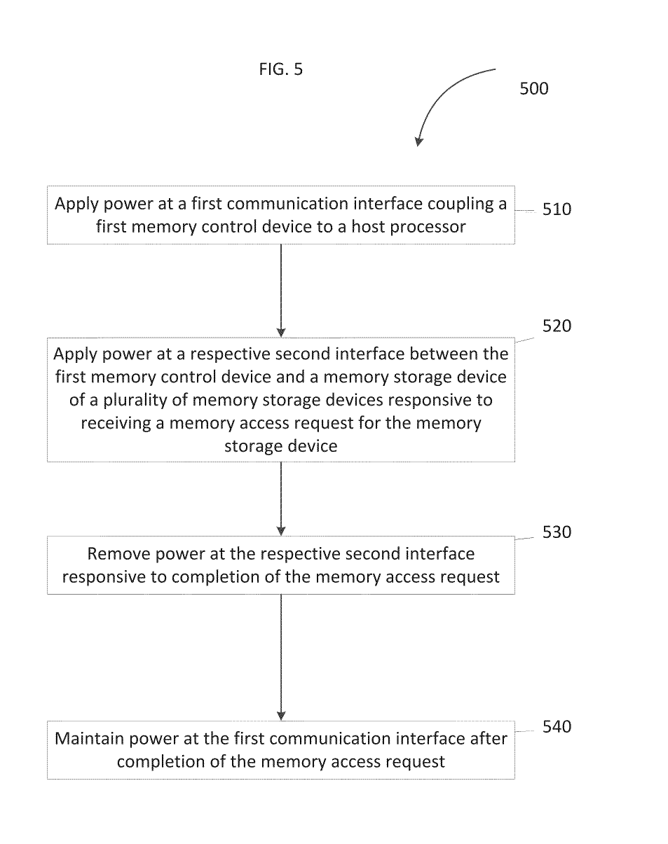

FIG. 5 is a flow diagram illustrating a method 500 for controlling power usage in a memory module 100 in accordance with some embodiments. The host processor 140 may perform the method 500 or a memory control device 110 or 120 may perform the method 400.

In operation 510, the host processor 140 may apply power at a communication interface 130. The communication interface 130 may couple a first memory control device 110 to the host processor 140. The communication interface 130 may be of a first type. For example, the communication interface 130 may be a SerDes interface.

In operation 520, the host processor 140 may apply power, or instruct the memory control device 110 to apply power, at a respective interface 170 between the memory control device 110 and a memory storage device 150 of a plurality of memory storage devices 150, responsive to receiving a memory request for the memory storage device 150. The plurality of memory storage devices 150 may couple to the memory control device 110 through respective communication interfaces 170 of a second type different from the first type.

The host processor 140 may set a data rate of a communication interface 170 of the communication interfaces 170 upon applying power to the memory module 100, based on a configuration of the memory module 100. Alternatively, the host processor 140 may instruct the memory control device 110 to set a data rate of a communication interface 170 of the communication interfaces 170 upon applying power to the memory module 100, based on a configuration of the memory module 100. For example, the host processor 140 or memory control device 110 or 120 may program the signaling data rate and termination scheme of the CCI upon booting up the memory module 100 to optimize bandwidth versus power. The host processor 140, memory control device 110 or 120, or other device may change the data rate of the CCI when the memory module 100 changes from a high activity state to a low activity state to provide further power usage optimizations. The host processor 140, memory control device 110 or 120, or other device may change the data rate of the CCI for memory use cases that may be more tolerant of higher latency.

The host processor 140 may set a data rate of a communication interface 170 of the communication interfaces 170 responsive to a memory request, based on a latency requirement of the memory request. Alternatively, the host processor 140 may instruct the memory control device 110 to set a data rate of a communication interface 170 of the communication interfaces 170 responsive to a memory request, based on a latency requirement of the memory request.

In operation 530, the host processor 140 may remove power at the respective communication interface 170 responsive to completion of the memory request, or the host processor 140 may instruct the memory control device 110 to remove power at the respective communication interface 170 responsive to completion of the memory request.

In operation 540, the host processor 140 may maintain power at the communication interface 130 after completion of the memory request.

Embodiments described herein may operate to utilize a tiered structure of memory control devices and memory storage devices, communicating through power-optimized communication interfaces, to reduce power usage and latency while increasing memory density of a memory module.

The above description and the drawings sufficiently illustrate some specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

What is claimed is:

1. A memory module comprising:
a first memory control device comprising a first logic die and a first memory storage layer coupled with the first logic die, the first memory control device including a first communication interface of a first type to couple to a host processor;
a first memory storage device coupled to the first memory control device through a second communication interface, the second communication interface being of a second type.

2. The memory module of claim 1, further comprising:
a second memory control device, comprising a second logic die and a second memory storage layer coupled with the second logic die, the second memory control device including a third communication interface of the first type to couple to the host processor; and
the second memory control device coupled to a second memory storage device through a fourth communication interface, the fourth communication interface being of the first type or the second type.

3. The memory module of claim 2, wherein
the first memory control device is coupled to a first plurality of memory storage devices through a plurality of communication interfaces,
the second memory control device is coupled to a second plurality of memory storage devices through a plurality of communication interfaces, and
the second memory control device is coupled to a memory storage device of the first plurality of memory storage devices.

4. The memory module of claim 3, wherein a memory storage device of the first plurality of memory storage devices comprises a memory storage die arranged in a vertical stack with a logic die.

5. The memory module of claim 3, wherein a memory storage device of the first plurality of memory storage devices comprises a vertical stack of memory storage dies and no logic die.

6. The memory module of claim 3, wherein a memory storage device of the first plurality of memory storage devices is a NAND-architecture flash memory device.

7. The memory module of claim 2, wherein the second memory control device is coupled to the first memory control device through a communication interface of the first type.

8. The memory module of claim 2, wherein the second memory control device is coupled to the first memory control device through a communication interface of the second type.

9. The memory module of claim 1, wherein the first type of communication interface operates at a higher bitrate than the second type of communication interface.

10. The memory module of claim 9, wherein the first type of communication interface is a Serializer/Deserializer (SerDes) interface and the second type of communication interface is a cube connect interface (CCI).

11. The memory module of claim 1, wherein the memory module is a dual in-line memory module (DIMM).

12. The memory module of claim 11, further comprising a SerDes interface coupling the first memory control device to a memory storage device of a second DIMM.

13. A memory control device comprising:
a first communication interface to communicate with a host processor;
a second communication interface to communicate with a first memory storage device remote from the memory control device;
a third communication interface to communicate with a second memory storage device remote from the memory control device and remote from the first memory storage device;
a memory storage die;
a logic die, coupled with the memory storage die, to
process memory requests received over the first communication interface from the host processor to determine which of the first memory storage device and the second memory storage device is being addressed by the memory requests, and
distribute the memory requests between the second communication interface and the third communication interface based on the determining.

14. The memory control device of claim 13, wherein the logic die is arranged in a vertical stack with the memory storage die.

15. The memory control device of claim 13, wherein the second communication interface arranged to operate at a lower power than the first communication interface.

16. The memory control device of claim 15, wherein the first communication interface is a Serializer/Deserializer (SerDes) interface and the second communication interface is not a SerDes interface.

17. The memory control device of claim 15, wherein the first communication interface is an optical interface and the second communication interface is not an optical interface.

18. The memory control device of claim 15, wherein the third communication interface is of a different type than the second communication interface.

19. The memory control device of claim 15, wherein the third communication interface is of a same type as the second communication interface.

20. The memory control device of claim 13, further comprising:
a fourth communication interface to communicate with a second memory control device, the fourth communication interface arranged to operate at a higher power than the second communication interface and the third communication interface.

21. The memory control device of claim 13, wherein the second communication interface communicates with a plurality of memory storage devices.

22. A memory module comprising:
a memory control device comprising a first logic die, the memory control device including a first communication interface of a first type to couple to a host processor;
a plurality of memory storage devices coupled to the memory control device through a respective plurality of second communication interfaces.

23. The memory module of claim 22, wherein
a first subset of the plurality of second communication interfaces are of the first type and a second subset of the plurality of second communication interfaces are of a second type that has a lower bitrate than the first type.

24. The memory module of claim 22, wherein a memory storage device of the plurality of memory storage devices comprises a memory storage die arranged in a vertical stack with a logic die.

25. The memory module of claim 22, wherein a memory storage device of the plurality of memory storage devices comprises a memory storage die and no logic die.

26. A method for controlling power usage in a memory module, the method comprising:
applying power at a first communication interface coupling a first memory control device to a host processor, the first communication interface being of a first type;
applying power at a second communication interface between the first memory control device and a memory storage device of a plurality of memory storage devices responsive to receiving a memory request for the memory storage device, the second communication interface being of a second type different from the first type;
removing power at the second communication interface responsive to completion of the memory request; and
maintaining power at the first communication interface after completion of the memory request.

27. The method of claim 26, further comprising:
setting a data rate of the second communication interfaces upon applying power to the memory module, based on a configuration of the memory module.

28. The method of claim 26, further comprising:
setting a data rate of the second communication interfaces responsive to a memory request, based on a latency requirement of the memory request.

29. The method of claim 26, further comprising:
performing an operation based on memory bits retrieved from a memory storage device without passing memory bits to the host processor.

30. The method of claim 26, further comprising:
detecting that the communication interface to a memory storage or a second memory control device has failed; and
selecting a second communication interface to use for communication with the memory storage or the second memory control device.

31. The method of claim 26, further comprising:
backing up data to a backup memory storage of the memory module.

32. The method of claim 31, wherein the backup memory storage is a NAND-architecture flash memory device.

33. A memory module comprising:
a first memory control device comprising a first logic die, the first memory control device including a first communication interface of a first type to couple to a host processor;
a first memory storage device coupled to the first memory control device through a second communication interface, the second communication interface being of a second type;
a second memory control device, comprising a second logic die, the second memory control device including a third communication interface of the first type to couple to the host processor; and
the second memory control device coupled to a second memory storage device through a fourth communication interface, the fourth communication interface being of the first type or the second type.

34. The memory module of claim 33, wherein
the first memory control device includes a memory die coupled to the first logic die, and the first memory control device is coupled to a first plurality of memory storage devices through a plurality of communication interfaces,
the second memory control device is coupled to a second plurality of memory storage devices through a plurality of communication interfaces, and
the second memory control device is coupled to a memory storage device of the first plurality of memory storage devices.

35. The memory module of claim 34, wherein the memory die is vertically stacked with the first logic die.

36. The memory module of claim 34, wherein a memory storage device of the plurality of memory storage devices comprises a memory storage die arranged in a vertical stack with a logic die.

37. The memory module of claim 34, wherein a memory storage device of the plurality of memory storage devices comprises a memory storage die and no logic die.
